(19) United States
(12) Patent Application Publication
(10) Pub. No.: US 2009/0085494 A1
(43) Pub. Date: Apr. 2, 2009

(54) IMPROVEMENT TO LIGHTING SYSTEMS

(75) Inventor: David Thomas Summerland, Old Dalby (GB)

Correspondence Address: QUINE INTELLECTUAL PROPERTY LAW GROUP, P.C., P O BOX 458, ALAMEDA, CA, 94501, US

(73) Assignee: E-Light Limited, Douglas, IO (GB)

(21) Appl. No.: 11/991,253

(22) PCT Filed: Sep. 4, 2006
(86) PCT No.: PCT/GB2006/003259

§ 371 Date: May 30, 2008

(30) Foreign Application Priority Data
Sep. 3, 2005 (GB) 0517959.3
Dec. 23, 2005 (GB) 0526338.9

(51) Int. Cl. H05B 41/36

(52) U.S. Cl. 315/291

(57) ABSTRACT

The present invention relates to power adaptors for solid state lighting units and fixtures, of a kind including light emitting diodes, one of the adaptors comprising an input for receiving a phase controlled input power signal of varying on-duration and a controller coupled to the input and operable to produce at least one pulsed output driving signal in which both the duration and height of the pulses are varied according to the on-duration of the input power signal, to thereby control a light intensity output of the solid state lighting unit, such that the output is made to vary in a way that substantially matches the intensity response of the human eye. Various other arrangements of power adaptors are described along with dimmer controllers for use with the power adaptors, including some which involve motion sensing techniques.

The present invention relates to lighting systems and lighting controllers, and in particular though not exclusively to improvements to dimmer controllers and power adaptors for solid state lighting units and fixtures.

Recently, solid state lighting units, such as those using light emitting diodes (LEDs), have been incorporated into conventional lighting systems, particularly those found in domestic settings e.g. homes and apartments etc. Solid state lighting units have become popular in domestic use for providing so-called ‘mood’ lighting, as described in co-pending UK patent applications GB0415794.7 and GB0426322.4. By providing three different colours of light emitting diodes (typically RGB—red, green and blue), it is readily possible to control an overall colour of illumination from the LED lighting units by independently varying intensity of output from each one of the different colour groups.

In GB0426322.4 a number of arrangements of power adaptors and dimming controllers are described for lighting systems having both incandescent and solid state lighting units.

Existing power adaptors, as described in GB0426322.4, can control the light intensity output and/or a colour characteristic of a solid state lighting unit by producing driving signals for the LEDs using conventional pulse width modulation, such that linear changes in the duty cycle (or on-duration) of the input power signal give rise to corresponding linear changes in the amount of power made available to the LEDs via the power adaptor. In general, since LEDs are linear over a relatively large portion of their light output efficiency curves, such that doubling the amount of power to them doubles their light output, up to the region where the onset of non-linearity begins

Linear variations in light output from the LEDs are quite adequate to provide pleasing ‘mood’ lighting for occupants of a domestic setting, however since the human eye's response is not linear; the levels of lighting may not always be appropriately and/or most efficiently scaled for the eye to fully appreciate the incremental changes and/or transitional hues as the light is alternately increased and decreased, particularly at low light levels.

It is an object of the present invention to provide a power adaptor for a solid state lighting unit that provides driving signals to the LEDs, such that the power level of each driving signal varies as a non-linear function of the amount of power available to the power adaptor, to thereby provide a variation in light output which substantially matches the response of a human eye.

The new generation of LEDs (such as Indium Gallium Nitride wafers) have greater power handling capabilities and improved light output efficiencies over the equivalent properties of their predecessors. However, a significant drawback of driving the new generation LEDs at higher input power is that their corresponding light output efficiencies rapidly decrease with increasing power. Hence, in order to derive more light from new generation LEDs at higher powers, a greater amount of input power is typically required in order to drive the LEDs. This therefore gives rise to a poor and inefficient return of power, which for a domestic user can be economically disadvantageous and potentially wasteful for the environment generally.

It is a further object of the present invention is to provide a power adaptor for a solid state lighting fixture that can drive the light emitters over an optimum range of their light output efficiency curves, so as to optimise the light output efficiency of the lighting fixture.

Lighting systems having both incandescent and solid state lighting units, as described in GB0426322.4, are able to provide possible cost savings and environmental benefits, when used ‘intelligently’ by a home owner. This usually involves physically turning off the incandescent lighting units when lighting is no longer required in the illumination environment (e.g. front room, bathroom and bedroom etc). However, not all home owners may wish to expend the effort of turning the incandescent lighting units off when leaving the illumination environment, or else may simply forget to do so. Therefore, it is possible that lighting may be left on unnecessarily for considerable periods (e.g. overnight), which may lead to unexpected additional cost for the homeowner.

It is a further object of the present invention to provide a dimmer controller that includes a motion sensor which monitors activity within the illumination environment, such that if no activity is detected within a predetermined period of time, the dimmer controller will set the power level of the output power signal to a standby power level, to thereby reduce power consumption of the associated lighting system.

Some or all of the above objects are provided by arrangements of the present invention as described hereinafter.

According to one aspect, the present invention provides a power adaptor for a solid state lighting unit, comprising:
an input for receiving a phase controlled input power signal of varying on-duration; and
a controller coupled to the input and operable to produce at least one pulsed output driving signal in which both the duration and height of the pulses are varied according to the on-duration of the input power signal, to thereby control a light intensity output of the solid state lighting unit.

According to another aspect, the present invention provides a lighting system, comprising:
a dimmer controller adapted to provide a phase controlled output power signal of varying on-duration;
a power adaptor, comprising:
   an input for receiving the output power signal; and
   a controller coupled to the input and operable to produce at least one pulsed output driving signal in which both the duration and height of the pulses are varied according to the on-duration of the output power signal,
and
a solid state lighting unit for receiving the pulsed output driving signal to thereby control a light intensity output of the solid state lighting unit.

According to another aspect, the present invention provides a power adaptor for a solid state lighting fixture of a type having an array of light emitters each having a characteristic light output efficiency curve, the power adaptor comprising:
an input for receiving a phase controlled input power signal; and
a controller coupled to the input and operable to provide at least one output driving signal to the array such that, in use, the driving signal causes the emitters to be operated over an optimum portion of their light output efficiency curves to prevent the light output efficiency of the emitters from falling below a predetermined threshold level to thereby optimise the light output efficiency of the solid state lighting fixture.

According to another aspect, the present invention provides a solid state lighting fixture, comprising:
an array of light emitters, each emitter having a characteristic light output efficiency curve; and
a power adaptor including:
   an input for receiving a phase controlled input power signal; and
      a controller coupled to the input and operable to control power to the array such that, in use, the emitters are operated over an optimum portion of their light output efficiency curves to prevent the light output efficiency of the emitters from falling below a predetermined threshold level to thereby optimise the light output efficiency of the lighting fixture.

According to another aspect, the present invention provides a dimmer controller for a lighting system, comprising:
an adjustment means to vary the power level of a phase controlled output power signal;
a motion sensor for detecting activity within the environment around the dimmer controller; and
a dimming module coupled to the motion sensor, wherein the dimming module is adapted to set the power level of the output power signal to a standby power level if no activity is detected within a predetermined period of time.

Embodiments of the present invention will now be described by way of example and with reference to the accompanying drawings in which:

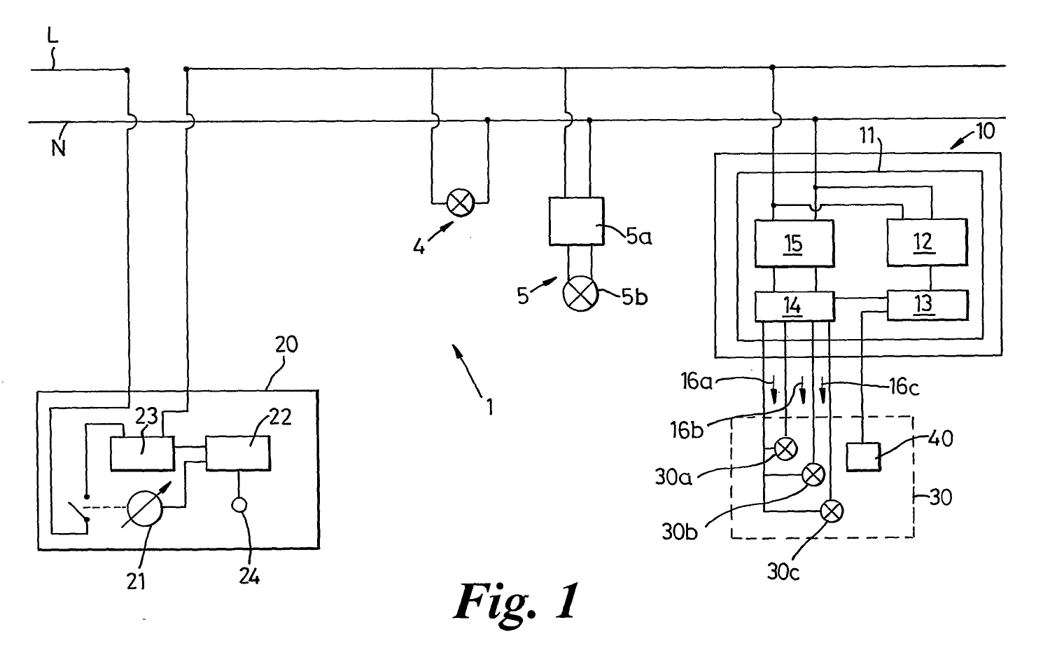

FIG. 1 is a schematic diagram of a lighting system according to preferred arrangements of the present invention.

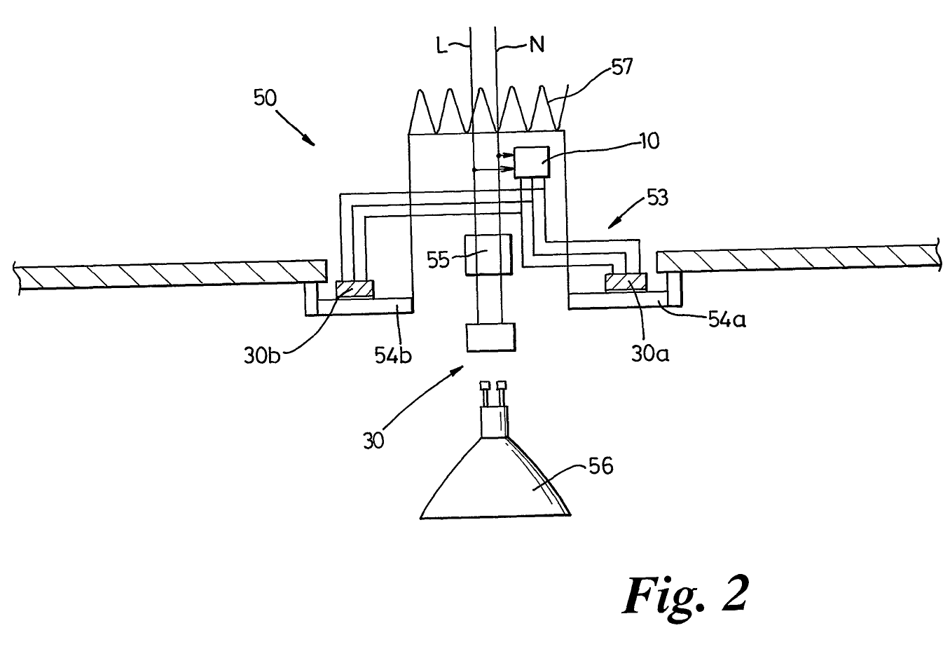

FIG. 2 is a schematic diagram of a solid state lighting unit according to a preferred arrangement.

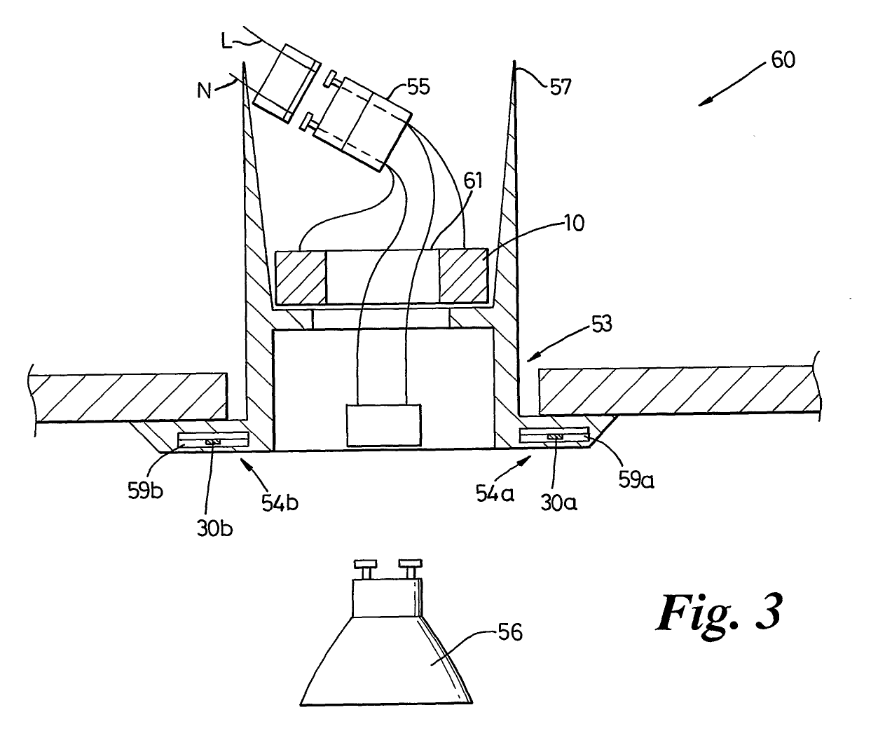

FIG. 3 is a schematic diagram of a solid state lighting unit according to another preferred arrangement.

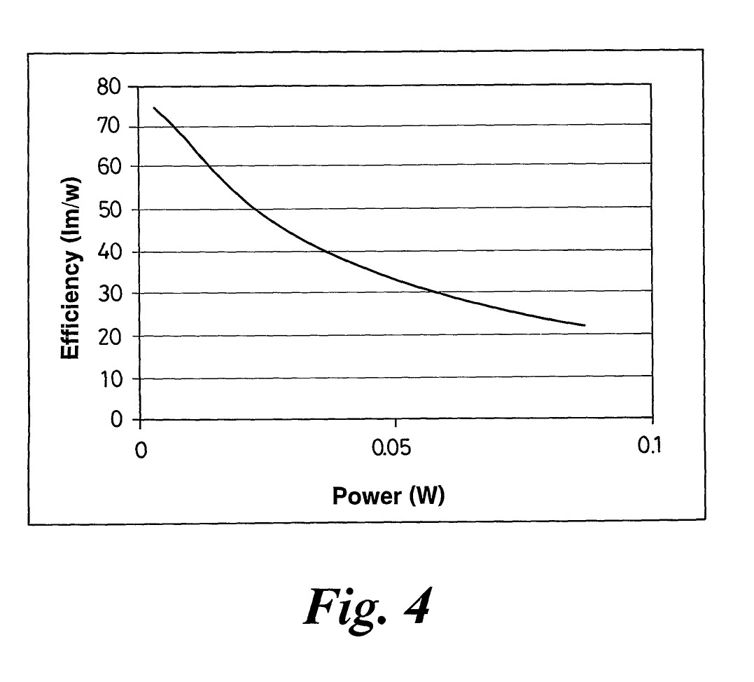

FIG. 4 is a graphical illustration of a typical new generation LED output light efficiency vs. input power curve.

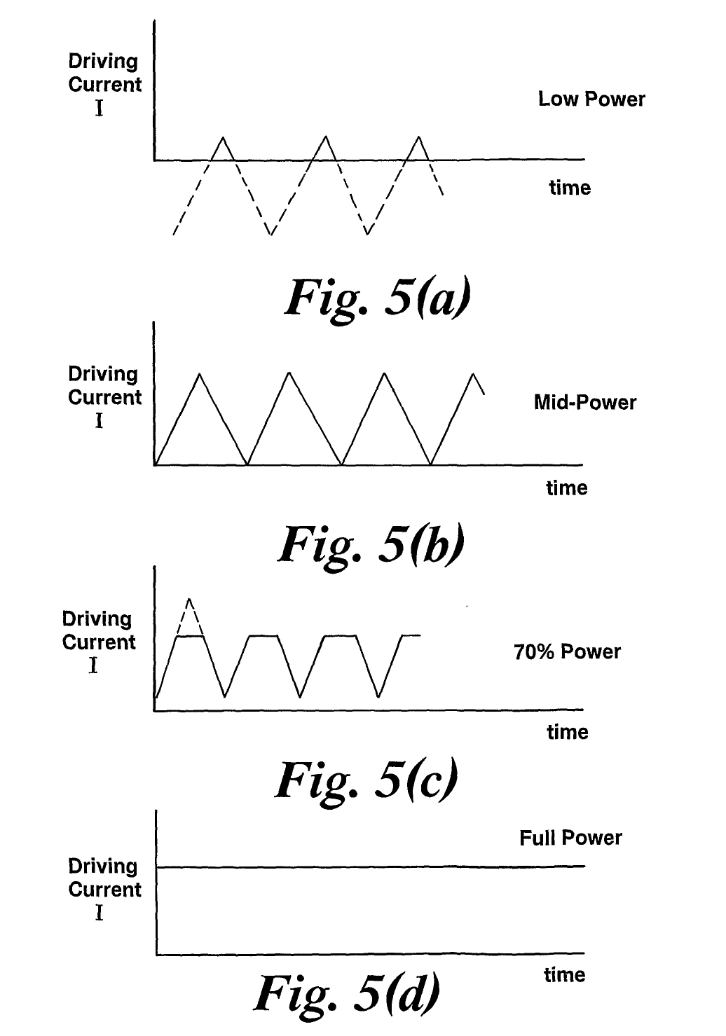

FIGS. 5(a)-(d) are graphical representations of example output driving signals from a preferred power adaptor according to the present invention.

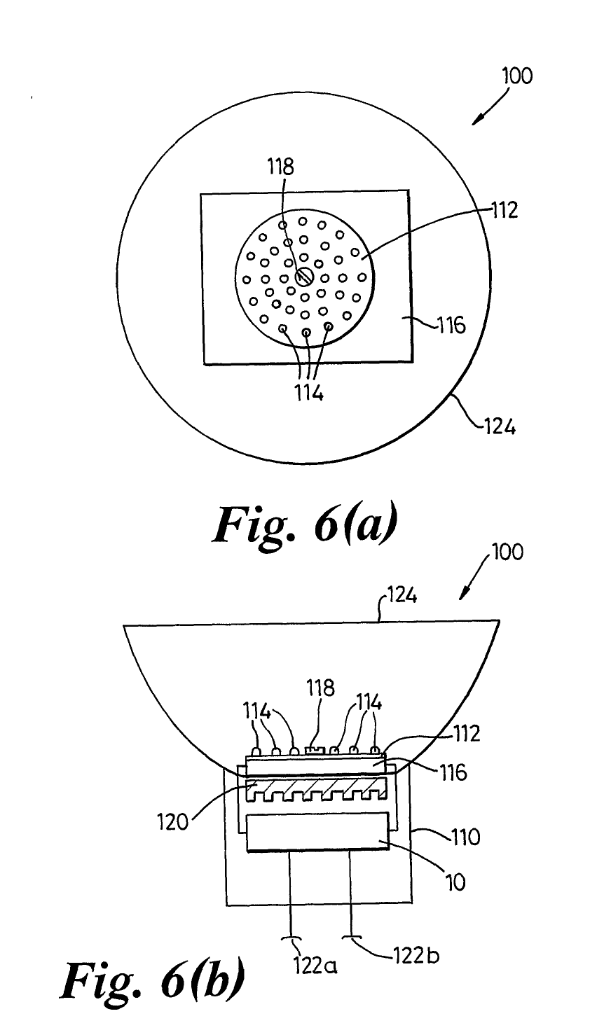

FIG. 6 is a schematic diagram of a solid state lighting fixture according to a preferred arrangement.

With reference to FIG. 1, there is shown a lighting system 1 according to preferred arrangements of the present invention. The lighting system 1 includes both incandescent lighting units 4, 5 and a solid state lighting unit 30. A dimmer controller 20 provides for connection of the incandescent lighting units 4, 5 to a mains supply L, N. In the schematic of FIG. 1, lighting unit 4 is a mains voltage incandescent lighting unit and lighting unit 5 is a low voltage halogen lighting unit comprising transformer 5a and at least one low voltage bulb 5b. The solid state lighting unit 30 is of a type as described in co-pending patent application GB0426322.4, comprising three coloured emitters 30a, 30b, 30c in a colour array, one each of red, green and blue LEDs.

It is to be appreciated that in other arrangements, the power supply for the lighting system 1 need not be a mains power supply, and instead any other suitable supply may be used, in particular, the supply could be 12VDC (as typically used on a boat and in camping vehicles), whereby L would be +12V and N 0V. Alternatively, the power supply lines L, N could be taken from an existing AC low voltage transformer (not shown), of a kind used with low voltage halogen or similar lighting, which typically provide 12VAC.

Associated with the solid state lighting unit 30 is a power adaptor 10, which connects to the mains supply L, N via the dimmer controller 20. The power adaptor 10 supplies electrical power to, and controls the output of, the solid state lighting unit 30. In preferred arrangements, the power adaptor 10 and solid state lighting unit 30 may be enclosed within a common housing of a type as described in co-pending patent application GB0426322.4.

It is to be appreciated that there may be any number of incandescent 4, 5 and/or solid state lighting units 30 in the lighting system 1, and that there will be preferably one power adaptor 10 per solid state lighting unit 30.

The two different lighting types—incandescent lighting units 4, 5 and solid state lighting unit 30—have significantly different electrical characteristics. The first type of lighting units have higher power requirements and are controllable in intensity by reducing the mains power that can be drawn by the lighting unit, conventionally by control of the voltage duty cycle of the mains supply. Preferably, this is done with phase-controlled variation in the voltage using a triac and/or thyristor dimming circuit.

By contrast, solid state lighting units have low power requirements and the intensity of individual solid state devices, such as the LEDs 30a, 30b, 30c, in a colour array is generally controlled by pulse width modulation of a constant low voltage supply. The intensity of different colour LEDs within the array may be independently controlled in order to effect a change in the colour characteristic output of the lighting system, or may be jointly controlled to effect a change in intensity only.

The power adaptor 10 actively monitors the amount of available power at the input of the adaptor via a controller 11. As shown in FIG. 1, the input is connected to the mains supply L, N via the dimmer controller 20, which is used to produce a phase-controlled variation in the output of the mains supply L, N. This may be achieved by controllably ‘chopping’ the sinusoidally varying waveform, using conventional techniques, so as to alter the mains supply duty cycle. The upshot of this is to make available a phase controlled input power signal of varying on-duration at the input of the power adaptor 10.

Herein, references to “on-duration” are to be taken as meaning the duration of the chopped component of the phase controlled power signal from the dimmer control 20. Hence, it is to be appreciated that variations in on-duration will give rise to corresponding variations in the power available at the input of the adaptor 10.

A power monitoring circuit 12 in the controller 11 either directly measures the available input power or monitors the variations in the output of the mains supply (e.g. by timing a triac firing) or both, to determine the on-duration and corresponding power level. The output of the monitoring circuit 12 is preferably an isolated analogue signal in the range of 0-5 volts, which may be calibrated such that substantially 0 V corresponds to a short (or zero) duty cycle and substantially 5 V corresponds to a high duty cycle, e.g. 100% of mains voltage duty cycle, respectively. Alternatively, the output of the power monitoring circuit 12 may be a digital signal which is encoded as a function of the on-duration of the input power signal. A further possibility is that the output could be a reduced amplitude representation of the input, as passed through a reducing transformer.

The analogue signal is converted into a digital input signal, using conventional means (not shown), and is supplied to a processor 13 in the controller 11. The processor 13 is programmed to output a control signal which is based on the power available, or on the on-duration of the input power signal, at the input of the adaptor 10. The control signal provides instructions to an output power module 14, within the controller 11, to effect a change in the colour characteristic output of the solid state lighting unit 30, or to effect a change in intensity, or both.

In accordance with an aspect of the present invention, the power output module 14 preferably provides at least two, and most preferably three, pulsed output driving signals 16a, 16b, 16c for control of the LEDs 30a, 30b, 30c in the colour array of the solid state lighting unit 30. Preferably, each of the output driving signals 16a, 16b, 16c is separately controllable and has a power level which varies as a non-linear function of the on-duration (and hence power) of the input power signal at the input of the adaptor 10.

The output driving signals 16a, 16b, 16c are pulse width modulated signals, which control the amount of power supplied to each of the LEDs 30a, 30b, 30c in the colour array by varying both the duration (herein “on-time”) and height (herein “amplitude”) of the pulses in each signal 16a, 16b, 16c. The power output module 14 is adapted to implement a power control technique that controls both the on-time and the amplitude of the driving pulses, thereby in effect applying two driving functions to each of the LEDS 30a, 30b, 30c. The effect of controlling both the on-time and amplitude of the pulses in the output driving signals is that the amount of power provided to the LEDs 30a, 30b, 30c is scaled non-linearly, for corresponding linear changes in the on-duration of the input power signal. In this way, the amount of power may be made to preferably scale as a squared function of the on-duration of the input power signal, whereby the power level of each output driving signal is based on a multiplicative relation between the on-time and the amplitude of the pulse.

An advantage of powering the LEDs 30a, 30b, 30c in accordance with a non-linear driving function is that the light output from the solid state lighting unit may be made to vary such that the output substantially matches the response of a human eye. It is known that the human eye is very sensitive to changes in intensity at low light levels, but relatively insensitive to changes in intensity at high light levels. Therefore, in accordance with this aspect of the present invention, the power adaptor 10 may be configured to produce small changes in intensity at low intensity levels, and large changes in intensity at high intensity levels, by driving the LEDs 30a, 30b, 30c in a non-linear fashion. In this way, the transitions from low to high light levels (and vice versa) and/or colour changes are found to be more comfortable for the eye, and moreover, are particularly well suited to the eye's response at low light levels, as the resolution of the solid state lighting unit 30 is increased at lower input power levels.

It is to be appreciated that the LEDs 30a, 30b, 30c may be driven by a non-linear function which has any desired functional form, including preferably squared, exponential and logarithmic, depending on the desired application and the manner in which the outputs from the LEDs 30a, 30b, 30c are to be matched the eye's intensity response profile.

In preferred arrangements, the power output module 14 is configured to provide the pulsed output driving signals as triangular saw-tooth waveforms. In order to vary the on-time and the amplitude of the pulses, the power output module 14 varies a D.C. offset associated with each output driving signal, relative to a reference ground level. In this way, the peaks of the triangular waveforms can be effectively shifted in height relative to ground, thereby providing more or less power to the LEDs 30a, 30b, 30c, as more or less of the triangular waveform is exposed relative to ground. In preferred arrangements, the D.C. offset is linearly varied from about 0 volts D.C. to about 5 volts D.C. peak pulse height.

Advantageously, since the pulses of the output driving signals are not actually switched on or off, but are instead merely shifted relative to ground, little, or no, radio-interference is found to originate from the power adaptor 10.

It is to be appreciated that the power output module 14 may use any suitable circuit arrangement to drive the LEDs 30a, 30b, 30c according to a non-linear driving function according to this aspect of the present invention.

As shown in FIG. 1, the power adaptor 10 also includes a power regulator 15, of a type, and operation, as described in co-pending application GB0426322.4. The power regulator 15 is operable to provide a substantially constant output power to the power output module 14 for as wide a range of available input power as possible.

The power adaptor 10 is operable to control an overall output intensity and/or colour characteristic output of the solid-state lighting unit 30 by way of a suitable lighting profile, as described in detail in the co-pending patent application GB0426322.4. According to this aspect of the present invention, the lighting profiles incorporate the non-linear driving function for the output driving signals, so as to scale the power provided to the LEDs 30a, 30b, 30c non-linearly.

Preferably, the processor 13 is programmed with a plurality of such lighting profiles, each one giving rise to a particular ‘mood’ lighting effect having an output intensity adapted to substantially match the response of a human eye at the given preferred colour.

The processor 13 is programmed to sequentially select a successive one of the lighting profiles whenever the power available at the input of the adaptor 10 (as indicated by the on-duration of the input power signal) is at a level which is insufficient to provide power for operation of the solid state lighting unit 30. This level corresponds to a power level at which the LEDs 30a, 30b, 30c are effectively off, and is herein referred to as the ‘minimum power level’.

Preferably, the minimum power level is non-zero, since a zero power level (and hence zero duty cycle) is regarded by the processor 13 as a re-set signal, causing the processor 13 to re-set the order of profile selection so as to start again from the first programmed profile.

In alternative arrangements, the processor 13 could be programmed to remember the last implemented profile in a non-volatile memory, so that when the power adaptor 10 is turned on from being off, the last profile may be selected in preference to the first programmed profile.

It is to be appreciated that the processor 13 may be programmed to sequentially select a profile in response to any specific available power level, for example, the next profile could be selected when the available power at the adaptor input corresponds to substantially 100% mains voltage duty cycle i.e. corresponding to maximum output intensity of the solid state lighting unit 30. Alternatively, the processor 13 may be programmed to respond to any ‘sudden’ change in available input power, e.g. by quickly rotating a dimmer control switch back and forth etc. within a prescribed time interval.

The processor 13 preferably contains 8 lighting profiles each giving rise to a particular lighting effect or ‘mood’ lighting. Of course, it is to be appreciated that the processor 13 may contain any number of profiles depending upon the particular lighting system and illumination environment in which it is intended to be used.

Preferably, each lighting profile (except the default profile) includes a transfer characteristic which causes the processor 13 to instruct the power output module 14 to produce a colour characteristic output of the solid state lighting unit 30 which is (i) contrasted towards substantially white when the input duty cycle is in the range of approximately 35% to approximately 100% of mains voltage duty cycle, and (ii) coloured light when the input duty cycle is in the range of approximately 20% to approximately 35% of mains voltage duty cycle.

By way of illustration, the transfer characteristics of exemplary profiles can be configured so that the following example colour characteristic outputs are produced when the input duty cycle is increased from a low duty cycle to a high duty cycle:
(i) dim green to bright green (using only a single LED) and then to white (using all 3 LEDs)
(ii) dim red to bright red (using only a single LED) and then to white (using all 3 LEDs)
(iii) dim yellow to bright yellow (using 2 LEDs) and then to white (using all 3 LEDs)
(iv) gradual transition through the spectral range—dim red to bright violet (using 1, 2 or 3 LEDs as appropriate) and then to white (using all 3 LEDs).

It is also possible to configure the transfer characteristics of the profiles so that the colour characteristic output is different when going from bright to dim, than when going from dim to bright as just illustrated. Hence, an exemplary profile may go from dim blue to bright blue then to white with increasing input duty cycle (or on-duration of the input power signal), and go from white to bright orange to dim orange as the duty cycle decreases.

In the case of the default profile, which is always selected whenever the power adaptor 10 is first turned on, the colour characteristic output is maintained at substantially white light throughout the range of input duty cycle.

In accordance with one or more aspects of the present invention, the power adaptor 10 is configured to allow the sequence of lighting profiles to be re-synchronised in response to detecting a pre-set switching event produced by the dimmer controller 20. Preferably, the pre-set switching event corresponds to a specific movement of the adjustment means, which in the case of the control knob 21 is preferably a rapid rotation of the knob through a predetermined angle, followed by a corresponding rapid angular rotation in the opposite direction. In preferred arrangements, the “predetermined angle” corresponds to substantially the full angular range of operation of the control knob 21, and the movement is such that the first rotation increases, the amount of power available at the input of the power adaptor 10, and the second rotation decreases the amount of power available at the input of the power adaptor 10. When the power adaptor 10 detects the resulting rapid variation in available power at its input (giving rise to a corresponding variation in input duty cycle), the processor 13 responds by re-setting the order of the lighting profile sequence in memory.

It is to be appreciated that the “pre-set switching event” may correspond to any suitable signal from the adjustment means or other controllable input device (e.g. an input from an associated input means and/or sensor), which is sufficiently unique to be identified by the processor 13 as a re-synchronisation signal.

The above technique is particularly advantageous in lighting systems having more than one coupled solid state lighting unit and power adaptor assembly, as several such assemblies can lose colour sequence synchronisation if one or more of the solid state lighting units are replaced over time. To avoid neighbouring assemblies from invoking different lighting profiles due to the order of their lighting profiles being out of synchronisation, an operator can operate the adjustment means to trigger the re-synchronisation of the power adaptors 10 via the pre-set switching event. Thereafter, as a consequence, each assembly invokes the same lighting profile sequence.

In accordance with another aspect of the present invention, there is provided a dimmer controller 20 for providing a phase controlled output power signal of varying on-duration, preferably a chopped A.C. mains power signal. In preferred arrangements, the dimmer controller 20 is in the form of a wall switch plate having an adjustment means, such as a rotary control knob 21, operable to vary the output of the mains supply L, N. The control knob 21 acts as both an intensity control and as a ‘mood’ colour control for the solid state lighting unit 30.

Preferably, the control knob 21 incorporates an isolation switch for isolating the lighting units 4, 5 and 30 from the output power signal of the dimmer controller 20. The isolation may be in the form of a push switch, operated by pushing the control knob 21 on its axis, or a limit switch actuated by turning the knob 21 to one extremity of its range, in accordance with known dimmer switch operation.

Alternatively, the adjustment means may be a slidable switch or an encoded control knob adapted for continuous rotation about a fixed axis, having no minimum or maximum mechanical end points.

In preferred arrangements, the dimmer controller 20 also comprises an input means 24 to receive an input signal from an operator to select a desired light intensity output and/or colour characteristic of the solid state lighting unit 30. The input means 24 provides the operator with an additional means of directly controlling the intensity and/or ‘mood’ colour, without physically manipulating the control knob 21. Preferably, the input means 24 is an infra-red sensor, which is configured to receive input signals from a suitable hand held remote control. Alternatively, the input means may be an acoustic sensor or wireless receiver.

In other arrangements, the input means 24 may be a push button switch or control pad mounted on the wall switch plate, which may be directly operated by the operator as desired.

In accordance with another aspect of the present invention, the lighting system 1 is configured to have a power saving mode, which is entered into whenever the illumination environment (e.g. home setting, office or industrial building) of the lighting system 1 is deemed to be no longer occupied or in use.

As shown in FIG. 1, the dimming module 22 of the dimmer controller 20 is coupled to a motion sensor 24 of a type for detecting activity of humans etc. within the environment around the dimmer controller 20. Preferably, the motion sensor 24 is in the form of a passive infra-red (PIR) based detector, mounted on the wall switch plate of the dimmer controller 20, and directly connected to the dimming module 22. Alternatively, the motion sensor 24 may be located remotely from the dimming module 22, at a selected vantage point within the illumination environment, and can either be hard wired or wirelessly connected to the dimming module 22 as desired.

In other preferred arrangements, the motion sensor 24 may be a thermal imaging sensor which detects activity within the environment by monitoring motion of humans etc. by tracing their thermal signature within successive thermal images.

Preferably, the PIR detector monitors the illumination environment for any activity, and if no motion is detected within a predetermined period of time, the dimming module 22 acts to set the power level of the output power signal (from the dimmer controller 20) to a standby power level. The standby power level is preferably a low power level, which is sufficient to provide power to operate a solid state lighting unit 30, but insufficient to operate an incandescent lighting unit 4, 5. In this way, when the dimmer controller 20 decides to implement the power saving mode of the lighting system 1, the incandescent lighting units are turned off and low level illumination can be provided by the low power LEDs 30a, 30b, 30c.

Such low level illumination is not only economical, but is also environmentally friendly, as the power consumption of the lighting system 1 is reduced while in the power saving mode.

An additional benefit of maintaining a low level of illumination is that it provides a measure of safety for an operator who subsequently re-enters the environment, as the risk of stumbling or tripping over unseen obstacles is significantly reduced. Moreover, the low level of illumination can be particularly advantageous if the operator is only briefing entering, or passing through, the illumination environment, as it may not be necessary to turn on the incandescent lighting units 4, 5, which therefore maintains the power saving mode of the lighting system 1.

Clearly therefore, the power saving mode of this aspect of the present invention is advantageous, as it may significantly reduce power consumption (and hence cost) as lighting is used only when and where it is needed, thereby benefiting both the operator and the environment.

The value of the standby power level and predetermined time period are preferably stored in a conventional nonvolatile memory within, or coupled to, the dimming module 22. The standby power level and time period may be factory set during fabrication of the dimmer controller 20, or else may be set by the operator, preferably using a pre-set sequence of switching operations recognised by the dimming module 22, e.g. by rapidly turning the control knob 21 in a prescribed manner, thereby enabling the level or period to be set and then committed to the non-volatile memory.

In preferred arrangements, the predetermined period of time is in the range of about 15 minutes to about 20 minutes. However, this range is not intended to be limiting and any suitable range may be used according to the desired inactivity period.

Preferably, the dimming module 22 includes a triac and/or thyristor dimming circuit so as to provide the output power signal to the lighting units 4, 5, and 30.

The operation of the lighting system as shown in FIG. 1, is as substantially described in co-pending patent application GB0426322.4, and is consistent with each aspect of the present invention.

A number of modifications may be made to the arrangements described in connection with FIG. 1, according to one or more aspects of the present invention.

As described in co-pending patent application GB00426322.4, the power regulator 15 may be replaced by a conventional D.C. power supply, which is preferably separate from the power adaptor 10. The D.C. power supply is connected across the mains supply L, N via a switch controlled by the processor 13 in controller 11. Preferably, the switch is a conventional mains rated switching device, such as a relay, triac or thyristor. The D.C. power supply connects to the live power supply line L in parallel with the dimmer controller 20, so that the supply is able to receive approximately 100% of the mains duty cycle whenever it is connected to the live line L. Hence, the power supply does not receive the phase-controlled variation in the output of the mains supply produced by the dimmer controller 20.

The output of the power supply 43 is used to provide a constant electrical power to the power output module 14 within the controller 11, whenever the power supply 43 is connected to the mains supply L, N.

In a preferred arrangement according to one or more aspects of the present invention, as shown in FIG. 2, the power adaptor 10 and solid state lighting unit 30 may be enclosed within a common housing of a plug-in fitting 50, that is preferably designed to be installed into a standard halogen type, recessed light socket 53, such as in a ceiling or wall. The LEDs 30a, 30b, 30c (only the first two are shown) are mounted within the housing so that light from each emitter is able to emerge from respective apertures 54a, 54b in an outwardly facing surface of the housing. The outwardly facing surface is preferably annular in form, and provides for a central aperture to preferably receive a standard halogen lamp 56 which connects to the mains supply L, N via a low voltage transformer 55, either integral, or external, to the housing. Preferably, the LEDs 30a, 30b, 30c are disposed within the housing so that their angular separation (about the central aperture) is approximately 120 degrees apart, although any suitable angular and/or spatial separation in the plane of the outwardly facing surface may be adopted.

To increase the light output efficiency of the LEDs 30a, 30b, 30c, each emitter may be provided with a substantially conical reflector as conventionally used in lighting devices.

Preferably, to assist with heat dissipation from the power adaptor 10, a heat sink 57 is provided, which minimises, or prevents, the risk of the plug-in fitting 50 from overheating during continuous periods of use.

In another preferred arrangement according to one or more aspects of the present invention, as shown in FIG. 3, the power adaptor 10 and solid state lighting unit 30 may be enclosed within another common housing of a plug-in fitting 60, that is also preferably designed to be installed into a standard halogen type, recessed light socket 53, such as in a ceiling or wall. Like features in both FIGS. 2 and 3 are labelled accordingly. The LEDs 30a, 30b, 30c (only the first two are shown) are mounted within the housing in the same manner as the arrangement in FIG. 2, and each preferably has an associated lens 59a, 59b, 59c to focus and direct the light into the illumination environment.

To prevent, or minimise, overheating occurring, the plug-in fitting includes a heat sink 57 to dissipate the heat from the halogen lamp 56 and LEDs 30a, 30b, 30c. The fitting also preferably includes a thermal vent 61, in the form of an aperture to allow excess heat from the halogen lamp 56 to convectively dissipate.

The use of plug-in fittings 50, 60 is advantageous, as the fittings may be simply installed by non-specialist technicians, such as typical homeowners, without the need for re-wiring of existing electrical connections. Moreover, the fitting can be conveniently located, and re-located, within any desired room of the home, provided a suitable dimmer controller 20 is available in that room, to thereby permit a particular ‘mood’ lighting to be selected.

Although the preferred arrangements require one power adaptor 10 per solid state lighting unit 30, it is within the scope of the invention to have a power output module 14 which can provide multiple groups of output driving signals which are capable of controlling a plurality of separate solid state lighting units 30 in accordance with one or more aspects of the present invention.

The solid state lighting unit 30 may also be fitted with a conventional temperature sensor 40 which could monitor the temperature within an associated housing and provide the adaptor processor 13 with an overheat signal. The processor 13 would be programmed to instruct the power output module 14 to temporarily interrupt, or indefinitely isolate, power to the potentially overheating solid state lighting unit 30 until such time that the signal is cancelled or re-set.

In accordance with another aspect of the present invention, the light output efficiency of the solid state lighting units can be improved by modifying the power adaptor of one or more of the preferred arrangements and/or changing the configuration of the solid state lighting unit. As discussed earlier, the efficiency of new generation LEDs is known to decrease markedly with increasing high input power. Therefore, there is an inherent lower return in luminous flux per watt at higher input powers.

Referring to FIG. 4, there is shown an example light output efficiency vs. input power curve (herein referred to as the “light output efficiency curve”), for a typical new generation LED (e.g. Indium Gallium Nitride 5T40BC-R-AU available from United Epitaxy Co. Ltd. www.uec.com.tw) for use with existing solid state lighting units. It is immediately evident that the efficiency (in lumens per watt) diminishes with increasing input power, such that beyond approximately 0.05 W the return in terms of luminous flux per watt of input power is significantly lower than in the regions below approximately 0.03 W for instance. Existing solid state lighting units overcome this fall off in efficiency by driving the LEDs with ever increasing power, so as to give rise to more available luminous flux. However, as noted previously, this technique is potentially wasteful of power and such inefficient use can lead to additional operating costs, which may be undesirable from a domestic user's point of view.

In a preferred arrangement therefore, the power output module 14 in the power adaptor 10 of the present invention (see FIG. 1) is configured to drive the solid state lighting unit 30 so that the LEDs 30a-c are operated over an optimum portion of their light output efficiency curves (corresponding to lower input powers—see FIG. 4), to thereby optimise the efficiency of the lighting unit In this way, the power adaptor 10 can maximise the output efficiency by driving the LEDs 30a-c over a substantially linear response portion of the light output efficiency curves, before the onset of non-linearity which occurs with increasing high input powers. This technique avoids significant wastage of power and provides a greater return in terms of luminous flux per watt of input power.

However, by operating the LEDs over a optimum portion of their efficiency curves (e.g. at lower input power), there will obviously be a reduction in the overall light output as compared to a corresponding solid state lighting unit being operated at a relatively higher input power. To offset this effect, it is possible to provide additional LEDs, so that even though each individual LED is being operated efficiently at low power, there are more of them to contribute to the overall light output of the lighting unit.

Hence, by combining the power adaptor 10 with more LEDs, it is possible to produce a more efficient lighting unit, that does not rely on driving the LEDs at ever increasing higher input powers so as to derive more available luminous flux. In preferred arrangements, the power output module 14 comprises a current limiting circuit which therefore prevents the power delivered to the LEDs from rising above a predetermined threshold. In this way, the available power can be selected so as to drive the LEDs over the preferred optimum portion of their light output efficiency curves.

Referring to FIGS. 6(a) and (b), there is shown a particularly preferred arrangement of a solid state lighting fixture 100 according to the present invention. The fixture comprises a housing 110, in which is enclosed the power adaptor 10 of the foregoing arrangement coupled to an array 112 of solid state light emitters, such as a plurality of LEDs 114. The array 112 preferably includes at least one emitter that emits light of a different colour to at least one other light emitter within the array. The light emitters are spatially arranged in a preferred radial pattern so as to permit good colour mixing of the output light, to thereby give rise to ‘mood’ lighting as discussed in detail with respect to the other preferred arrangements.

Of course, any suitable spatial arrangement may be adopted that provides good colour mixing of the output light.

The fixture 100 is preferably a plug-in fitting, that is designed to be installed into a standard halogen type, recessed light socket (not shown), such as in a ceiling or wall etc. The array 112 of light emitters each have a characteristic light output efficiency curve, such as that illustrated in FIG. 4, as is typical for a new generation LED.

It is to be appreciated that different colour LEDs, will generally not have the same light output efficiency curves. However, as a good approximation the respective efficiency curves may be averaged or mathematically convolved so as to provide a “model efficiency curve” which may then be used to select an optimum portion over which the LEDs are to be operated.

The LEDs 114 are mounted to a conventional printed circuit board 116, although it is to be appreciated that any suitable mounting arrangement may be used. The printed circuit board is preferably attached to the housing by way of a screw 118 or other fixing device. To avoid overheating in the fixture 100, a conventional heatsink 120 is attached to the reverse side of the printed circuit board, so as to dissipate any excess heat generated by the LEDs during use.

Power is provided to the array 112 by way of the power adaptor 10, which has an input connected to electrical contacts 122a and 112b. The input is arranged to receive a phase controlled input power signal from any of the dimmer controllers of the present invention.

To increase light transmission efficiency and directionality, a conventional conical reflector 124 is provided, which is connected to the housing 110 using any suitable means. It is to be appreciated that any appropriate form or shape of reflector may be used in the lighting fixture of the present invention.

In preferred arrangements, the optimum portion of the LED light output efficiency curves is selected so as to correspond to local lighting regulations. For example, in the UK, this may be the fixed internal lighting regulations as stipulated by the “2006 Edition of the Building Regulations: Conservation of fuel and power”, as published by the Office of the Deputy Prime Minister. These regulations require that any new lighting fixtures should provide an output efficiency of 40 lumens per watt or greater. Therefore, the power output module 14 is configured to provide a driving signal to the array 112 which causes the LEDs 114 to be operated over an optimum portion of their light output efficiency curves and which prevents the light output efficiency from falling below a predetermined threshold level, preferably corresponding to a light output efficiency of at least 40 lumens per watt for the array as a whole. In this way, the fixture advantageously conforms to the required lighting regulations, and thereby ensures efficient use of input power and an effective return in terms of luminous flux.

It should be appreciated however, that the predetermined threshold may be selected to correspond to any appropriate light output efficiency level, depending on the particular application and solid state devices used. For example, the predetermined threshold may be selected to correspond substantially to the onset of non-linearity in the light output efficiency curve.

To permit greater control of the LEDs 114 in the array 112, a triangular saw-tooth waveform, as described earlier, is preferably used as the output driving signal from the power adaptor 10 (see FIG. 5). The output driving signal has a power level that varies as a non-linear function of the power of the input power signal (as derived from the dimmer controller). In order to increase the light output from the LEDs 114 over the optimum portion of their light output efficiency curves, the power adaptor 10 is configured to cause the triangular waveform to saturate at higher input powers. In this way, more power can be delivered to the LEDs 114 as the efficiency begins to gradually decrease towards the higher power end of the optimum portion of their light output efficiency curves. This is illustrated in FIGS. 5(a) to 5(d), where the output driving signal is triangular in form over a portion of its power range, as shown in (a) and (b), corresponding to relative low and mid-power respectively, which is typically below about 50% of the maximum power level of the output driving signal.

However, as the input power increases, the output driving signal begins to saturate at around 70% of its maximum power level, which thereby provides more power to the array 112 in the lighting fixture 100 as the on-time is correspondingly increased. When the output driving signal attains its maximum power level, and consequently saturates, the power adaptor provides continuous direct current to the array 112, which is selected to be at a level which gives rise to a light output efficiency which is approximately 40 lumens per watt or greater.

As the input power is decreased, the output driving signal de-saturates and once again adopts its triangular waveform, thereby providing greater control over the LEDs at lower input power.

Other arrangements are intentionally within the scope of the accompanying claims.

1. A power adaptor for a solid state lighting unit, comprising:
an input for receiving a phase controlled input power signal of varying on-duration; and
a controller coupled to the input and operable to produce at least one pulsed output driving signal in which both the duration and height of the pulses are varied according to the on-duration of the input power signal, to thereby control a light intensity output of the solid state lighting unit.

2. The power adaptor of claim 1, in which the output driving signal has a power level that varies as a non-linear function of the on-duration of the input power signal.

3. The power adaptor of claim 2, in which the non-linear function has a form which substantially matches an intensity response profile of a human eye.

4. The power adaptor of claim 1, in which the non-linear function is a squared function.

5. The power adaptor of claim 1, in which the power level of the output driving signal is based on a multiplicative relation between the duration and the height of the pulses.

6. The power adaptor of claim 1, in which the output driving signal is a pulse width modulated signal.

7. The power adaptor of claim 1, in which the controller varies a D.C. offset associated with the output driving signal relative to ground, to vary the duration and height of the pulses in the signal.

8. The power adaptor of claim 7, in which the D.C. offset is linearly varied from about 0 volts D.C. to about 5 volts D.C. peak pulse height, relative to ground.

9. The power adaptor of claim 1, in which the output driving signal is a triangular saw-tooth waveform.

10. The power adaptor of claim 1, in which the power level of the output driving signal scales as a squared function with linear changes in on-duration of the input power signal.

11. The power adaptor of claim 1, in which the controller is operable to produce at least two pulsed output driving signals in which both the duration and height of the pulses in each signal are varied according to the on-duration of the input power signal, to thereby control a light intensity output and/or color characteristic of the solid state lighting unit.

12. A lighting system, comprising:
a dimmer controller adapted to provide a phase controlled output power signal of varying on-duration;
a power adaptor, comprising:
an input for receiving the output power signal; and
a controller coupled to the input and operable to produce at least one pulsed output driving signal in which both the duration and height of the pulses are varied according to the on-duration of the output power signal,
and
a solid state lighting unit for receiving the pulsed output driving signal to thereby control a light intensity output of the solid state lighting unit.

13. The lighting system of claim 12, further comprising one or more incandescent lighting units configured to receive the output power signal from the dimmer controller.

14. The lighting system of claim 13, in which, the output power signal is a chopped A.C. mains signal.

15. The lighting system of claim 12, in which the pulsed output driving signal is a triangular saw-tooth waveform.

16. The lighting system of claim 12, in which the controller is operable to produce at least two pulsed output driving signals in which both the duration and height of the pulses in each signal are varied according to the on-duration of the output power signal, to thereby control a light intensity output and/or color characteristic of the solid state lighting unit.

17. A dimmer controller for a lighting system, comprising:
an adjustment means to vary the power level of a phase controlled output power signal;
a motion sensor for detecting activity within the environment around the dimmer controller; and
a dimming module coupled to the motion sensor, wherein the dimming module is adapted to set the power level of the output power signal to a standby power level if no activity is detected within a predetermined period of time.

18. The dimmer controller of claim 17, in which the standby power level is a low power level, corresponding to a level substantially below the power level required to operate an incandescent lighting unit.

19. The dimmer controller of claim 17, in which the standby power level is sufficient to provide power to operate a solid state lighting unit but insufficient to operate an incandescent lighting unit.

20. The dimmer controller of claim 17, in which the standby power level is stored in a non-volatile memory.

21. The dimmer controller of claim 17, in which the dimming module is adapted to respond to a user input to define the standby power level.

22. The dimmer controller of claim 17, in which the dimming module is adapted to respond to a user input to define the predetermined period of time.

23. The dimmer controller of claim 17, in which the predetermined period of time is in the range of about 15 minutes to about 25 minutes.

24. The dimmer controller of claim 17, in which the motion sensor is an infra-red based detector.

25. The dimmer controller of claim 17, in which the dimming module includes a triac and/or thyristor dimming circuit.

26. The dimmer controller of claim 17, in which the dimmer controller is in the form of a wall switch plate for attaching the dimmer controller to a wall surface.

27. The dimmer controller of claim 26, in which the motion sensor is either integral to the wall switch plate or remotely located from the wall switch plate.

28. A lighting system, comprising:
a dimmer controller according to claim 17;
a power adaptor configured to receive the output power signal from the dimmer controller; and
a solid state lighting unit coupled to the power adaptor;
wherein the dimmer controller sets the power level of the output power signal to the standby power level if no activity is detected within a predetermined period of time, the standby power level corresponding to a low illumination state of the solid state lighting unit,

29. The lighting system of claim 28, further comprising one or more incandescent lighting units configured to receive the output power signal from the dimmer controller.

30. A power adaptor for a solid state lighting fixture of a type having an array of light emitters each having a characteristic light output efficiency curve, the power adaptor comprising:
an input for receiving a phase controlled input power signal; and
a controller coupled to the input and operable to provide at least one output driving signal to the array such that, in use, the driving signal causes the emitters to be operated over an optimum portion of their light output efficiency curves to prevent the light output efficiency of the emitters from falling below a predetermined threshold level to thereby optimize the light output efficiency of the solid state lighting fixture.

31. The power adaptor of claim 30 wherein the optimum portion corresponds to a substantially linear response portion of the light output efficiency curve.

32. The power adaptor of claim 30, wherein the predetermined threshold level corresponds substantially to the onset of non-linearity in the light output efficiency curve.

33. The power adaptor of claim 30, wherein the output driving signal is sufficient to operate the array of light emitters so as to provide a light output efficiency of at least about 40 lumens per watt over the optimum portion of the light output efficiency curve.

34. The power adaptor of claim 30, wherein the output driving signal has a power level that varies as a non-linear function of the power of the input power signal.

35. The power adaptor of claim 30, wherein the output driving signal has a power level that saturates at around the maximum power level of the output driving signal.

36. The power adaptor of claim 35, wherein the controller is configured to provide continuous direct current to the array at the maximum power level of the output driving signal.

37. The power adaptor of claim 30, wherein the output driving signal is a triangular saw-tooth waveform over a portion of its power range.

38. The power adaptor of claim 37, wherein the portion corresponds to below about 50% of the maximum power level of the output driving signal.

39. The power adaptor of claim 30, wherein the controller comprises a current limiting circuit to limit the power provided to the array.

40. A solid state lighting fixture, comprising:
an array of light emitters, each emitter having a characteristic light output efficiency curve; and
a power adaptor including:
an input for receiving a phase controlled input power signal; and
a controller coupled to the input and operable to control power to the array such that, in use, the emitters are operated over an optimum portion of their light output efficiency curves to prevent the light output efficiency of the emitters from falling below a predetermined threshold level to thereby optimize the light output efficiency of the lighting fixture.

41. The lighting fixture of claim 40, wherein the optimum portion corresponds to a substantially linear response portion of the light output efficiency curve.

42. The lighting fixture of claim 41, wherein the predetermined threshold level corresponds substantially to the onset of non-linearity in the light output efficiency curve.

43. The lighting fixture of claim 40, wherein the array is configured to provide a light output efficiency of at least about 40 lumens per watt when operated over the optimum portion of the light output efficiency curve.

44. The lighting fixture of claim 40, wherein the array comprises a plurality of spatially arranged light emitters.

45. The lighting fixture of claim 44, wherein the array includes at least one light emitter that emits light of a different color to at least one other light emitter within the array.

46. The lighting fixture of claim 44, wherein the light emitters are light emitting diodes.

47. A lighting system, comprising:
a dimmer controller operable to provide a phase controlled output power signal;
a power adaptor according to claim 30 configured to receive the output power signal from the dimmer controller; and
a solid state lighting fixture having an array of light emitters each having a characteristic light output efficiency curve.

48. The lighting system of claim 47, further comprising one or more incandescent lighting units configured to receive the output power signal from the dimmer controller.

49. Apparatus as substantially described herein with reference to the accompanying drawings.
